(19) United States
(12) Patent Application Publication
(10) Pub. No.: US 2008/0077727 A1
(43) Pub. Date: Mar. 27, 2008

(54) Multithreaded state machine in non-volatile memory devices

(76) Inventors: Jim S. Baca, Corrales, NM (US); Nicholas Woo, Albuquerque, NM (US); Mark Price, Placitas, NM (US); Yiming Yang, Albuquerque, NM (US)

Correspondence Address: LEE & HAYES, PLLC;c/o INTELLEVATE, P.O. BOX 52050, MINNEAPOLIS, MN, 55402, US

(21) Appl. No.: 11/526,360

(22) Filed: Sep. 25, 2006

(51) Int. Cl. G06F 12/00

(52) U.S. Cl. 711/103

(57) ABSTRACT

Various embodiments allow a non-volatile memory device to manage multiple process requests from an associated computing device. In at least some embodiments, a multi-threaded state machine is included in the supporting logic of the non-volatile memory device. Multiple process requests are received by the non-volatile memory device and serviced in a multi-threaded fashion.

### BACKGROUND

Flash memory devices, like other non-volatile memory devices, are often utilized by computing devices such as digital cameras, mobile phones, pagers, handheld computers and the like. These memory devices typically include a memory array of transistors and supporting logic which includes an integrated single-threaded state machine. One limitation of single-threaded machines, and memory devices that rely on them, is that such machines and devices can only accommodate one process request (for commands/tasks such as read, write or erase) from the computing device at a time. For instance, a read operation cannot be processed when another operation, such as a write operation for example, is already being performed. Accordingly, management software residing on the computing device (but external to the flash memory device) is utilized to manage the numerous process requests typically made by the computing device to the flash memory device. Unfortunately however, this solution requires computational overhead which can negatively impact the performance of the computing device. For instance, management software must consume many cycles in order to handle the prioritized management of read/write/erase requests made to the flash device and its integrated single-threaded state machine. Furthermore, substantial time and effort must be expended in maintaining and updating this software.

### BRIEF DESCRIPTION OF THE DRAWINGS

FIG. 1 illustrates an exemplary system in accordance with one embodiment.

FIG. 2 illustrates an exemplary flash memory device in accordance with one embodiment.

FIG. 3 is a flow diagram that describes acts in a method in accordance with one embodiment.

### DETAILED DESCRIPTION

In the embodiments below, the; task of coordinating the execution of simultaneous read and write requests made by a computing device is moved from management software residing on the computing device but external to its memory device, to the memory device itself. In at least some embodiments, this is accomplished by including a multi-threaded state machine in the command logic of the memory device. As will be appreciated by one skilled in the art and in view of the discussion below, this can ultimately result in improved performance and lower software maintenance costs.

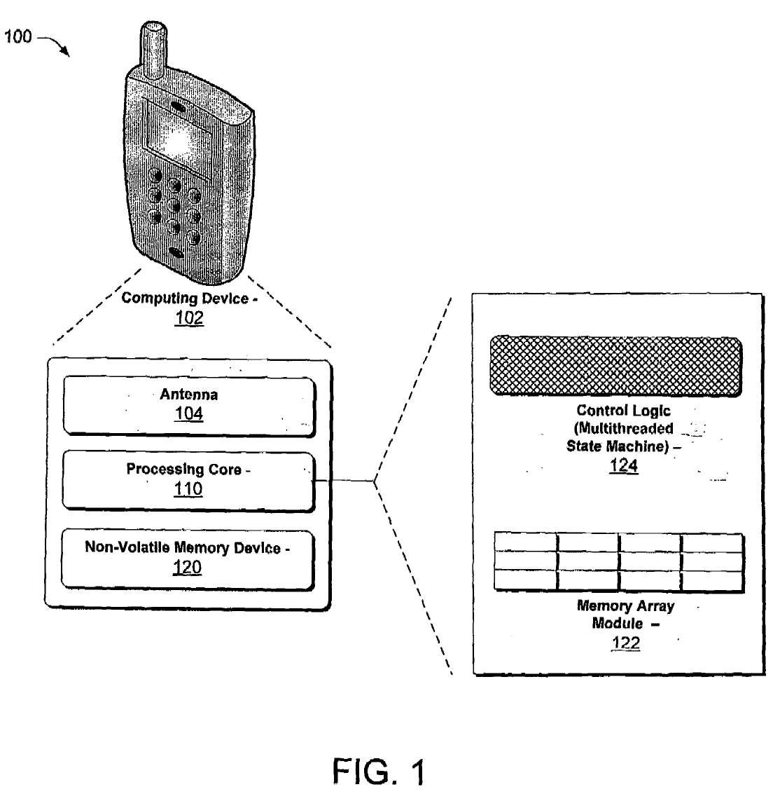

FIG. 1 illustrates, generally at 100, an exemplary system in which the principles and methods described above, and below can be implemented in accordance with one embodiment. System 100 includes, in this example, computing device 102, which in turn includes at least one antenna 104, at least one processing core 110 (which includes processing components and related memory systems) and a non-volatile memory device 120. Processing core 110 is capable of communicating with various components of computing device 102 (some of which are not illustrated here), including non-volatile memory device 120.

Although computing device 102 is depicted as a mobile phone, it is to be appreciated and understood that any suitable computing device can be utilized without departing from the spirit and scope of the claimed subject matter. Other suitable computing devices can include, by way of example and not limitation, desktop or portable computers, digital cameras, pagers, handheld computers such as personal digital assistants (PDAs) and the like.

Continuing, process requests from computing device 102 are received by non-volatile memory device 120, typically via a bus (not shown). Computing device 102 can be communicatively coupled with non-volatile memory device 120 in any suitable way. Further, non-volatile memory device 120 can either be permanently affixed or removably attached to computing device 102.

As illustrated, non-volatile memory device 120 includes memory array module 122 and its supporting logic, depicted here as control logic 124. Typically, memory array modules, like memory array module 122, include a plurality of transistors, such as floating gate transistors and the like, that implement the storage elements of the non-volatile memory device. In this particular embodiment, control logic 124 includes a multi-threaded state machine, as will be described in greater detail below. In at least some embodiments, the multi-threaded state machine is fabricated on the same substrate, such as a silicon substrate, as the memory array module. Hence, the multi-threaded state machine is integrated with the memory array module.

In operation, computing device 102 makes process requests to non-volatile memory device 120 and the multi-threaded state machine facilitates processing those requests. These process requests are often made to non-volatile memory device 120 when it is already busy performing an operation associated with a previous request.

In these instances, the multi-threaded state machine can process the requests by, for example, queuing up the requests, prioritizing the requests, performing arbitration relative to the requests: and associating available resources and the like, in a multi-threaded fashion as will be appreciated by the skilled artisan. For example, consider a user who is reading, editing and creating email messages on a mobile phone device. If the user receives an incoming phone call during this time, the mobile phone device may attempt to identify the incoming caller by searching the user's address book—held in memory on the flash device. To accomplish this, a caller identification process on the phone device will make a “read” operation request to the flash memory device—which may already be engaged in either a “read”, “write” or “erase” operation with respect to the user's email messaging activities. Here, these incoming requests can be handled by the multi-threaded state machine in a multi-threaded fashion to improve the efficiency of the phone device's overall handling of the requests.

This constitutes a dramatic improvement over past single-threaded approaches which could not handle and efficiently or effectively process multiple requests, but rather utilized software to process these requests.

Here, the multi-threaded state machine of control logic 124 allows non-volatile memory device 102 to accommodate multiple process requests at the same time. This, in turn, allows the task of managing multiple requests to be handled by the non-volatile memory device itself, and relieves the burden of this processing from external device software

To provide some tangible context for the reader to appreciate the role of multi-threaded state machines in the particular context described herein, consider the following. The control logic of a memory device includes a state machine to handle the transitions of the memory device from one state to the next. For instance, if the current state of the memory device is that it is being engaged in a read process, the state machine can define conditions that cause transitions from that state—as by defining the conditions that suspend the read process. Likewise, that state machine can define conditions that transition to and from, as well as suspend, other processes such as write processes, erase processes, and the like. Any number of such operations or processes can be so executed as a “thread” by the state machine in response to process requests made to the memory device. Unlike single-threaded state machines, multi-treaded state machines can initiate two or more of these operations simultaneously or pseudo-simultaneously, as will be appreciated and understood by those skilled in the art. This means that operations associated with multiple process requests can be received and managed and multiple threads can be allocated and performed by a memory device that includes a multi-threading state machine, such as non-volatile memory device 120 depicted here.

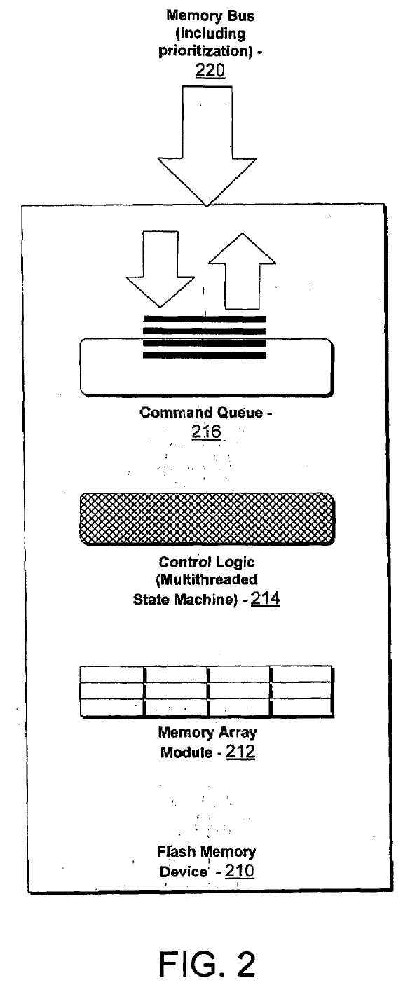

FIG. 2 illustrates an exemplary non-volatile memory device in the form of a flash memory device 210, in accordance with one embodiment. As discussed above, suitable non-volatile memory devices, such as flash memory device 210, are often utilized by computing devices such as digital cameras, mobile phones, pagers, handheld computers and the like. While the following discussion describes a memory device in the form of a flash memory device, it is to be appreciated and understood that any suitable non-volatile memory device can be utilized, without departing from the spirit and scope of the claimed subject matter. By way of example and not limitation, a suitable non-volatile memory device can include “Not-Or” (NOR) flash memory, “Not-And” (NAND) flash memory, or the like.

Here, a memory bus 220 operably connects flash memory device 210 with other components, such as a processor (not specifically shown), on an associated computing device such as computing device 102 depicted in FIG. 1. Memory bus 220 allows flash memory device 210 to receive process requests from the associated computing device. In at least some embodiments, such as the one illustrated here, process requests can, but need not, have a designated priority. Any suitable means for prioritizing process requests can be implemented.

As illustrated, flash memory device 210 includes, among other things, a memory array module 212 and its supporting logic, here depicted as control logic 214. Control logic 214 includes a multi-threaded state machine which, as discussed above, allows flash memory device 210 to accommodate and manage multiple processes requests at the same time. By way of example, and not limitation, this management can include discerning different process requests and their priorities, arbitrating various operations associated with these process requests (for example, reading, writing or erasing data in the memory array module), caching retrieved data, and ensuring that these operations are completed. 100181 Also included on flash memory device 210 is a command queue 216 where various commands, associated with various process requests received by flash memory device 210, can be held until they are serviced. Control logic 214 can poll this queue and service each command therein under the influence of the multi-threaded state machine. Commands can be placed or otherwise ordered in the command queue and/or serviced based upon any suitable criteria. By way of example, and not limitation, this order can be based on the designated priority of the process requests corresponding to the commands and/or on the identity of the requesting processes themselves.

Again, note that process request management functions, traditionally performed by software external to the memory device, are performed here by flash memory device 210 in a multi-threaded fashion. This is beneficial because, as discussed above, flash memory device 210 can manage process requests in a more efficient and timely manner than external software can. On reason for this is the overhead consumed by the external software. For instance, mutual exclusion algorithms, abstract data types and other related processing means typically employed by such software require significant computational resources. Furthermore, maintaining and upgrading this software can be time consuming and expensive.

Consider again the example above involving a user using a mobile phone device to read, edit, and create email messages. By utilizing a flash memory device that includes a multi-threaded state machine, the mobile phone device's performance is no longer negatively impacted by various software drivers handling the various process requests associated with features such as email messaging and caller identification. As such, the user enjoys a faster, more efficient mobile phone device. Furthermore, less software maintenance and upgrading are necessary.

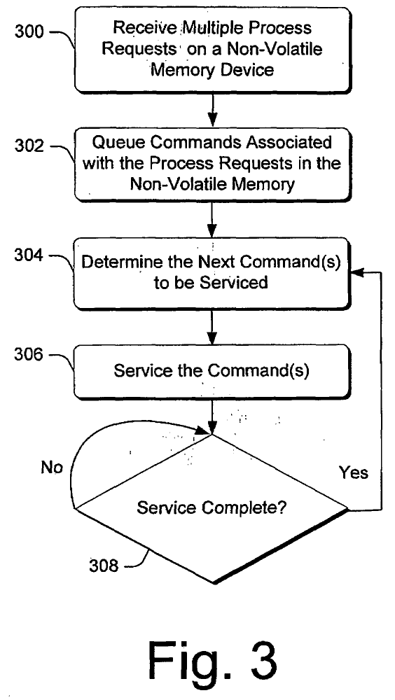

FIG. 3 is a flow diagram that describes acts in a method in accordance with one embodiment. The acts can be performed in connection with any suitable type of device that utilizes non-volatile memory, such as flash memory.

Act 300 receives multiple process requests on a non-volatile memory device. The non-volatile memory device can accommodate any suitable number of process requests at any particular time. In at least some embodiments, the non-volatile memory device has control logic that includes a multi-threaded state machine. In addition, as noted, above,: these process requests can be made by an associated computing device and are typically received via a bus.

Act 302 queues commands associated with the received process requests on the non-volatile memory device. As noted above, commands can be queued according to any suitable criteria. Commands can designate operations such as “reading”, “writing” or “erasing” data. In at least some embodiments, such as those described above, this act is performed by control logic on the non-volatile memory device.

Act 304 determines a next command or commands to be serviced. This includes, but is not necessarily limited to, polling a command queue (containing the queued commands) and ascertaining which command(s) in the queue have the highest designated priority. In at least some embodiments, such as those described above, this act is performed by control logic on the non-volatile memory device.

Act 306 services the command(s). Servicing typically entails performing one or more operations associated with the command(s). For instance, if a command is to “read” from a memory array module on the non-volatile memory device, the operation is the performance of reading from the memory array module. In at least some embodiments, such as those described above, this act is performed by control logic on the non-volatile memory device.

Act 308 determines whether the service is complete. This typically entails ascertaining whether the performance of the operation associated with the command being serviced has successfully finished. Here, if the service of the command is not complete (i.e. “no” branch), act 308 loops back to complete the command. Note that this act can be repeated any number of times until it is determined that the service is complete (i.e. “yes” branch). When this happens (“yes”), acts 304-308 are repeated for any subsequent commands. Hence, the next command(s) to be serviced will be determined.

Some or all of the acts described in this example can be performed under the influence of the multi-threaded state machine. Specifically, processing of the multiple requests, as exemplified in acts 300-308, can be handled in a multi-threaded fashion to provide for fast and efficient execution of the commands.

Conclusion

The various principles and methods described above allow a non-volatile memory device with a suitable multi-threaded state machine, rather than management software external to the device, to manage process requests from an associated computing device. Accordingly, the overhead and performance penalty associated with relying on external management software, along with the cost and effort of creating and maintaining this software, can be mitigated.

Although the embodiments have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

What is claimed is:

1. A system comprising:
a non-volatile memory device having a non-volatile memory array; and
a multi-threaded state machine located on the non-volatile memory device and operably coupled with the non-volatile memory array, wherein the multi-threaded state machine is fabricated on, the same substrate as the non-volatile memory array.

2. The system of claim 1, further comprising a computing device embodying said non-volatile memory device.

3. The system of claim 2, wherein said non-volatile memory device is configured to multi-threadedly manage a plurality of process requests received from said computing device by simultaneously performing multiple operations associated with the plurality of process requests on the non-volatile memory device.

4. The system of claim 2, further comprising a command queue located on said non-volatile memory device and configured to store process requests received from said computing device.

5. The system of claim 2, wherein said non-volatile memory device is removeably attached to said computing device.

6. The system of claim 1, wherein said non-volatile memory device comprises a flash memory device.

7. The system of claim 6, wherein said flash memory device comprises a “Not-Or” (NOR) or “Not-And” (NAND) flash device.

8. A computing device comprising:
at least one antenna; and
a non-volatile memory device associated with the at least one antenna, wherein the non-volatile memory device is configured to multi-threadedly manage a plurality of process requests from the computing device by simultaneously performing multiple operations associated with the plurality of process requests on the non-volatile memory device.

9. The system of claim 8, wherein the non-volatile memory device comprises:
a non-volatile memory array module; and
a multi-threaded state machine operably coupled with the non-volatile memory array, wherein the multi-threaded state machine is fabricated on the same substrate as the non-volatile memory array module.

10. The system of claim 8, wherein said non-volatile memory device is further configured to manage said plurality of process requests by:
receiving said plurality of process requests on said non-volatile memory device; and
queuing commands associated with the plurality of process requests on said non-volatile memory device.

11. The system of claim 10, wherein said queuing comprises storing said commands in a command queue on the non-volatile memory device in an order based, at least in part, on the designated priorities of process requests associated with the commands.

12. The system of claim 8, wherein said non-volatile memory device is removeably attached to said computing device.

13. The system of claim 8, wherein said non-volatile memory device comprises a flash memory device.

14. A method comprising:
receiving a plurality of process requests on a non-volatile memory device, the process requests pertaining to operations that can be performed relative to a memory array module on the device;
queuing commands associated with the plurality of process requests on the non-volatile memory device; and
multi-threadedly performing one or more operations associated with the commands by using a multi-threaded state machine, wherein the multi-threaded state machine is fabricated on the same substrate as the memory array module and operably coupled with the memory array module.

15. The method of claim 14, wherein said non-volatile memory device is embodied on a computing device.

16. The method of claim 15, wherein said non-volatile memory device is removeably attached to said computing device.

17. The method of claim 14, wherein said non-volatile memory device comprises a flash memory device.

18. The method of claim 17, wherein said flash memory device comprises a “Not-Or” (NOR) or “Not-And” (NAND) device.

19. The method of claim 14, wherein two or more of said plurality of process requests can be received at one time.

20. The method of claim 14, wherein said queuing comprises storing said commands in a command queue on the non-volatile memory device in an order based, at least in part, on the designated priorities of the process requests associated with the commands.

21. One or more computer-readable media having computer-readable instructions thereon which, when executed by one or more processors, cause the one or more processors to implement the method of claim 14.
